(19) United States
(12) Patent Application Publication
(10) Pub. No.: US 2024/0315907 A1
(43) Pub. Date: Sep. 26, 2024

(54) Exercise Device

(71) Applicant: Lyn Steven Maher, West Hills, CA (US)

(72) Inventor: Lyn Steven Maher, West Hills, CA (US)

(21) Appl. No.: 18/592,788

(22) Filed: Mar. 1, 2024

Related U.S. Application Data
(60) Provisional application No. 63/453,323, filed on Mar. 20, 2023.
(60) Provisional application No. 63/520,996, filed on Aug. 22, 2023.

(51) Int. Cl. A61H 1/00; A61H 23/02

(52) U.S. Cl. CPC A61H 1/005; A61H 23/02; A61H 2201/0161; A61H 2201/1604; A61H 2201/1633; A61H 2201/5002; A61H 2201/5005; A61H 2201/5048

(57) ABSTRACT

An exercise apparatus comprises a base frame including a base frame connector, and a movable frame including a movable frame connector. The movable frame connector connects to the base frame connector so the movable frame is rotatable relative to the base frame. A platform is mounted on the movable frame member, and the platform has at least two different widths. An actuator is located between the base frame and the movable frame, and moves the movable frame relative to the base frame about the base frame connector so as to position the movable frame relative to the base frame in a selected position. A first vibration motor having a first intensity is provided for vibrating one area of the platform, and a second vibration motor having a second intensity is provided for vibrating another area of the platform.

### CROSS REFERENCE TO RELATED APPLICATIONS

This application claims the benefit of United States Provisional Patent Application No. 63/453,323 filed Mar. 20, 2023, and United States Provisional Patent Application No. 63/520,996 filed Aug. 22, 2023, both of which are incorporated herein in their entirely.

### FIELD AND BACKGROUND

This invention relates to an exercise device or apparatus. More particularly, the invention relates to an exercise device or apparatus which may be motorized. The exercise apparatus, whether motorized or not, has parts and components which are adjustable relative to each other, so that) a user may configure the exercise apparatus according to the level of difficulty desired by the user, or dictated by the user's physical fitness level and condition.

Some of the best body strengthening exercises are the push-ups and the plank exercises. Traditionally, however, these need to be done on the floor. At this horizontal position, the exercises may be very difficult for many people, and, at this angle, it may place considerable pressure on the wrists and shoulders. After the exercise is completed, it is necessary to get up off the floor, another movement which may be difficult for many people.

### SUMMARY

According to one aspect of the invention, there is provided an exercise apparatus comprising: a base frame including a base frame connector; a movable frame including a movable frame connector, the movable frame connector being connected to the base frame connector such that the movable frame is rotatable relative to the base frame; a platform mounted on the movable frame member to move with the movable frame member, the platform having at least two different widths; an actuator located between the base frame and the movable frame, the actuator being operated by a motor, the actuator moving the movable frame relative to the base frame about the base frame connector so as to position the movable frame relative to the base frame in a selected position; and a first vibration motor for vibrating one area of the platform and having a first intensity and a second vibration motor for vibrating another area of the platform and having a second intensity.

In one embodiment, the base frame comprises a substantially U-shaped tubular frame having two ends, a substantially vertical post extending upwardly from each end, the base frame connector being located at each of the ends. Further, the base frame further may comprise a front cross piece near one end thereof, and an intermediate cross piece, the actuator being connected to the base frame at the intermediate cross piece thereof.

Preferably, the movable frame comprises a substantially U-shaped tubular frame having two ends, the movable frame connector being located at each of the ends. The movable frame may comprise a cross piece extending across the movable frame, the actuator being connected to the movable frame at the cross piece thereof.

In one embodiment, the actuator comprises a telescoping extender positioned between the movable frame and the base frame, the actuator comprising a housing and a telescoping portion which selectively projects from or is contained within the housing, and wherein the position of the telescoping portion relative to the housing determines the angular position of the movable frame relative to the base frame. The actuator may be operated by a motor. Further, a remote control device may be provided for selectively activating the motor. The device may include a power source for the motor, the power source being selected from one or more of a battery, an external AC power source, or a combination thereof.

In one embodiment, a platform is mounted on the movable frame, the platform providing a substrate for supporting a user of the exercise apparatus. There may be at least one arm rest mounted on the platform. Further, there may be at least one handle mounted on the platform.

The exercise apparatus of the invention may also include and incorporate a pair of vibration motors, such as, for example, at the back of the platform. The presence of such a vibration motors has the added benefit of providing the option for vibration training, using two differently located vibration motors, each of the vibration motors being able to operate at different intensities. The vibration motors are in one embodiment preferably attached to the approximate center and top of the back of the platform, although other attachment positions may be used, and selectively activated by the user when desired. Different degrees or levels of vibration can be achieved independently for each vibration motor, and these may coordinate or cooperate with up and down movement of the platform.

Preferably, the movable frame can be angularly positioned and fixed at a selected angle relative to the base frame.

This invention therefore relates to a device or apparatus, the apparatus having adjustable relative positions, and vibration intensities which may be selected according to location. The apparatus may be moved between such adjustable relative positions by means of a motor, and the different selectable positions are determined by a user based on his requirements for a workout. Different positions of the exercise apparatus result in different degrees of difficulty for performing tasks on the apparatus.

In one aspect, the exercise device is one which makes it easier and more effective from a workout perspective to do push-ups, the plank, as well as other exercises. The device includes a platform that a user can lean on while doing exercises. The device further comprises a pair of frames, to be described more fully below, which move relative to each other, and adjuster members, or actuators, for configuring the pair of frames relative to each other and fixing them in a desired position.

Each adjuster member may have an associated motor for activating the adjuster member, and such motors may be controlled remotely. In one form of the invention, the adjuster members may comprise a pair of actuators, and these may be in the form of pneumatic or hydraulic devices, or electrically powered device which may include a rotating and telescoping screw, extending between the two frames, so that the frames can be moved closer or further apart from each other by appropriately activating these electric motors, or the pneumatic or hydraulic devices.

The selection of the relative position between the two frames determines the degree of difficulty for which an exercise may be carried out. The ability to select such relative positions offers the user the ability to control the difficulty of his or her exercise.

The relative positions of the platform can be set so as to move during exercise without real time input so provide an exercise schedule. The vibration motors may be similarly operated.

Therefore, in one aspect, the invention provides an easier stationary and moving position to perform exercises which, without the apparatus of the invention, may have been too difficult for certain sectors of the population to carry out. Another aspect of the invention is that the ability to change relative positions of the pair of frames allows the user to configure the pair of frames so that the exercise is easier initially, but can be made incrementally more difficult as the user schedule progresses and as the user acquires more strength over time.

The apparatus of the invention allows persons to exercise at preferred and more compatible positions, based on the person's physical strength and condition. Whereas such exercises may have previously been carried out on a floor or flat surface, the exercise apparatus of the invention allows the user to carry out such exercises while standing or at least on his or her feet on an angled platform, the angle being adjustable based on current needs.

### BRIEF DESCRIPTION OF THE DRAWINGS

In the drawings:

FIG. 1 is a side perspective view of an exercise apparatus in accordance with the invention, shown in the near upright position;

FIG. 2 is a front perspective view of the exercise apparatus at a first inclined position;

FIG. 3 is a detailed view showing the exercise device in one embodiment with a controller and other features;

FIG. 4 is a front perspective view of an exercise device in accordance with a further embodiment of the invention, in the generally upright position;

FIG. 5 is a front perspective view of the exercise device of FIG. 4, in the generally horizontal position;

FIG. 6 is a top view of the lower frame of the exercise device;

FIG. 7 is a view showing a vibration motor located on an exercise apparatus of the invention;

FIG. 8 is a front view of a seat or platform used on an exercise device of the invention;

FIG. 9 is a view of an exercise device with armrests;

FIG. 10 is a view of an exercise device with handles;

FIG. 11 is detail showing a remote controller on mobile phone or a tablet app for controlling and/or programming the exercise apparatus of the invention;

FIG. 12 is a rear view of the exercise apparatus in one embodiment thereof showing linear actuators that can lift and lower weights, including those weights which may be in excess of 500 lbs.;

FIG. 13 is a front view of a platform having two widths in accordance with an embodiment;

FIG. 14 is a detail view of an exercise apparatus which may be used with either a movable wireless remote control and/or an attached or wired remote control;

FIG. 15 is a detail rear view of the exercise apparatus with two separate vibration motors, consisting of a lower (lighter) vibration motor having a mild intensity vibration and an upper (darker) vibration motor having a stronger intensity vibration;

FIG. 16 is a front view of a platform for the exercise apparatus of one embodiment, including a headrest and a foldout seat; and

FIG. 17 is a front perspective view if an exercise machine in one embodiment.

### DETAILED DESCRIPTION

Reference is now made to the accompanying drawings, which show various embodiments and positions of an exercise device 10 in accordance with the present invention.

The exercise device 10 comprises a lower fixed frame 12, and an upper adjustable frame 14. The lower frame 12 and the upper frame 14 are connected to each other at a pair of pivot points 16 and 18, and the upper frame 14 is able to rotate or pivot about the pivot points 16 and 18 so that its position can be adjusted and varied relative to the lower fixed frame 12.

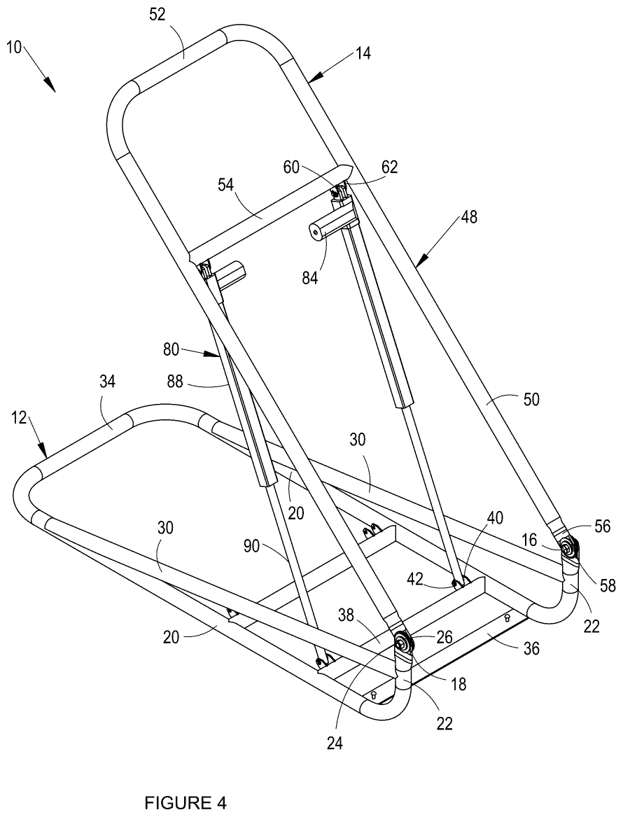

The lower fixed frame 12 comprises a pair of base frames 20 (best seen in FIG. 4 of the drawings), each having a substantially vertical post 22 at one end thereof. Each post 22 has a flattened end 24 with an aperture 26 therein. The lower fixed frame further comprises a pair of ascending bars 30 which extend from near the back of the base frames 20 to the post 22. These bars 30 provide additional strength and stability to the lower fixed frame 12. The lower fixed frame 12 further comprises a rear cross piece 34.

The lower fixed frame 12 further comprises a front cross piece 36. There is also provided an intermediate cross piece 38 between the base frames 20, and the intermediate cross piece 38 has near each end thereof a pair of upwardly directed plates 40 defining a small space 42 between them.

The upper frame 14 comprises a U-shaped tube 48 having a pair of parallel sides 50, and an end 52. A cross piece 54 extends between the sides 50. Each side 50 has a flattened end 56 and an aperture 58. The aperture 26 on the posts 22, and the aperture 58 on the sides 50, register with each other and are secured to each other by a pivot, bolt, or other hardware, so that the upper frame 14 can rotate about the pivot relative to the lower fixed frame 12.

The cross piece 54 has extending somewhat downwardly therefrom a pair of plates 60 near each end thereof, each pair of plates 60 defining a space 62. The function of these plates 60 will be described below.

A pair of actuators 80 is provided, one on each side of the exercise device 10, whereby the relative positions of the lower fixed frame 12 and the upper frame 14 can be adjusted. The actuator 80 is connected at one end to the cross piece 54, and at its other end to the intermediate cross piece 38. At its upper end, each actuator 80 connects to and is received within the space 62 of the plates 60. At its lower end, each actuator 80 connects to and is received within the space 42 between the plates 40. The connection of the actuators 80 at each end thereof is of the pivotal type, so that the ends of the actuators 80 can rotate or pivot within the respective spaces 42 and 62 of the plates 40 and 60, respectively.

Each actuator 80 may have a motor 84. These motors 84 can be battery-powered, receive power from an electrical household or other outlet, or such other source as may be convenient. The motors 84 may be positioned at any convenient location on the device. Each actuator 80 comprises a housing portion 88, and a telescoping portion 90. The telescoping portion 90 can move into and out of the housing portion 88, and such movement may be hydraulically or pneumatically effected, electrically or electronically, or by electric or manual rotation of a screw in a housing. When the telescoping portion 90 telescopes outwardly from the housing portion 88, the lower frame 12 and the upper frame 14 are moved away from each other. Conversely, when the telescoping portion 90 is withdrawn into the housing portion 88, the upper frame 14 is moved toward the lower frame 12. In this way, the upper frame 14 can move between a position in which it is nearly or substantially vertical, and a position in which it is nearly or substantially horizontal. These two opposing positions can clearly be seen in FIGS. 18 and 19 of the drawings, respectively. Any incremental and intermediate position may be attained, and fixed as necessary, by appropriate adjustment.

The upper frame 14 may be positioned relative to the lower fixed frame 12 in any incremental position between the substantially vertical and the substantially horizontal. Therefore, by appropriate control and activation of the motors 84, the actuators 80 will move so that the angle of the upper frame 14 can be suitably selected and fixed in position by simple operation of the user. In other embodiments, these frame members may be programmed to move during the exercise routine between multiple selected positions, so that the angle changes during the exercise according to a schedule, for better exercising routines.

There are clear advantages to an exercise device constructed in accordance with the present invention, and operative so as to vary the angle of the upper frame 14. It is well-established, and exercisers and trainers acknowledge, that performing an exercise such as a push-up is more difficult for a person when carrying out that exercise on a flat horizontal surface. However, it is much easier to perform such exercises when the body is not in a horizontal position. The more vertical the position of the body, the easier it is to do the push-up, or some other appropriate exercise. The exercise apparatus of the invention addresses this very point. A person who, for one reason or another, is not able to carry out push-ups or the plank when in a generally horizontal position, may well be able to do so when pushing away from the suitably positioned upper frame 14 of the exercise device of the present invention. Moreover, the ability to incrementally adjust the position of the upper frame 14 relative to the lower frame 12 allows the person to assume more and more difficult positions as he or she becomes fitter and stronger. Therefore, a person may start out using the upper frame 14 in the near vertical position, but over time, and upon gaining strength and fitness, is able to move the upper frame 14 incrementally so that it is at an angle relative to the lower frame, causing the body of the person to become more horizontal. The usefulness of the exercise device therefore remains even as the user's strengths and needs evolve.

The exercise apparatus 10 of the invention therefore facilitates and assists in the gradual strengthening of a user, with the ability to make the exercise more and more difficult as strength is gained.

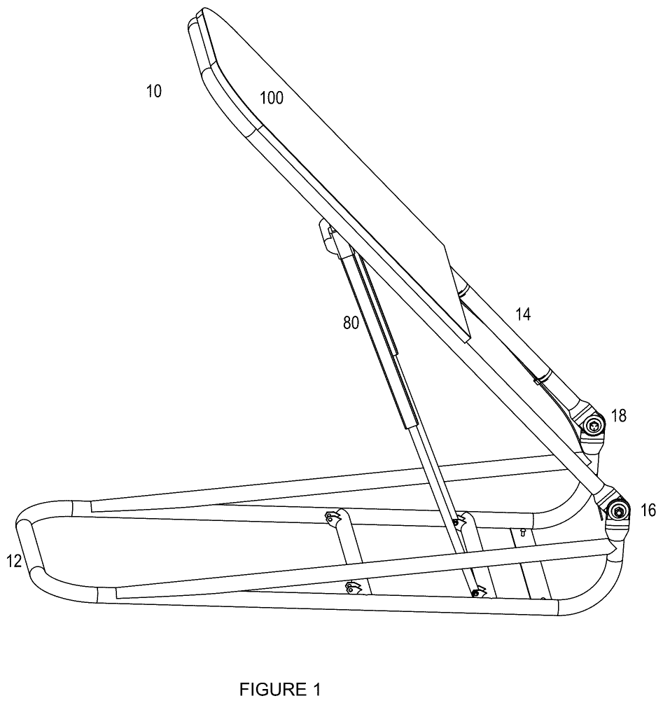

FIG. 1 of the invention shows a side perspective view of the exercise device 10, with the upper frame 14 in a not quite vertical position, but at about an 80° angle. This should be an optimal position for a person starting out, and who still needs to gain strength, and this position can be used until the person is ready for a more difficult or strenuous workout. It will be seen that the upper frame 14 has a platform 100 near the top thereof, providing a solid surface on the upper frame 14 against which the person can lean.

Depending on the relative angles, the person may be leaning forward, more so than he would be doing with the upper frame 14 positioned as in FIG. 1. The exercise is somewhat more difficult as the user leans to become more and more horizontal.

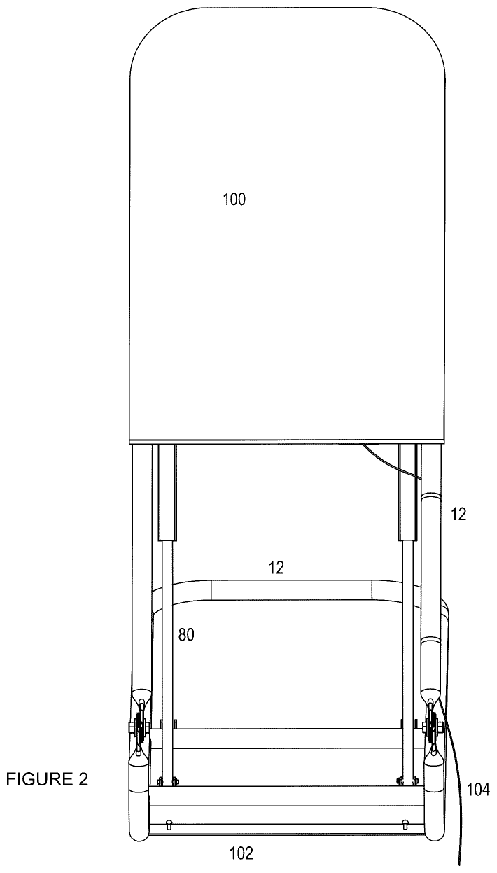

FIG. 2 of the drawings shows a front perspective view of an exercise device in accordance with the invention. It can be clearly seen in this figure the position of the platform 100. The user is able to lean on, or grasp, the platform or parts thereof to stabilize herself. FIG. 2 also shows studs 102, which may be used for anchoring a match to the device. Alternately, wheels may be provided to facilitate movement of the device. Further, an electrical connector 104 is also shown, whereby the exercise device 10 can be connected to a power source for providing the necessary power to the actuators 80.

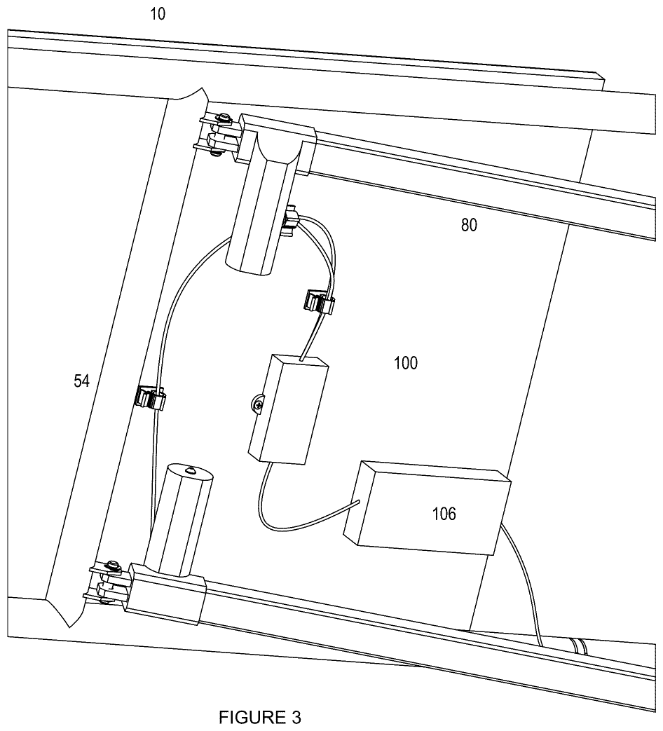

FIG. 3 shows a detail of a portion of the exercise device 10, including a controller 106 for operating the motorized actuators 80, and for receiving instructing signals from a remote control device. As such, simply pressing one or more buttons on a remote device activates the actuators 80, moving the upper frame 14 away from, or toward, the lower fixed frame 12, and which can be stopped at exactly the desired position, or programmed to move in various manners during the exercise routine. The invention may also include provision of preset positions so that a user can rely on a consistent configuration of the exercise device 10 from one session to another.

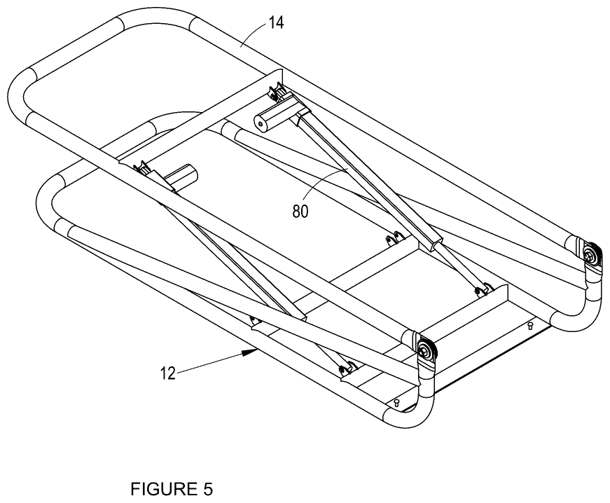

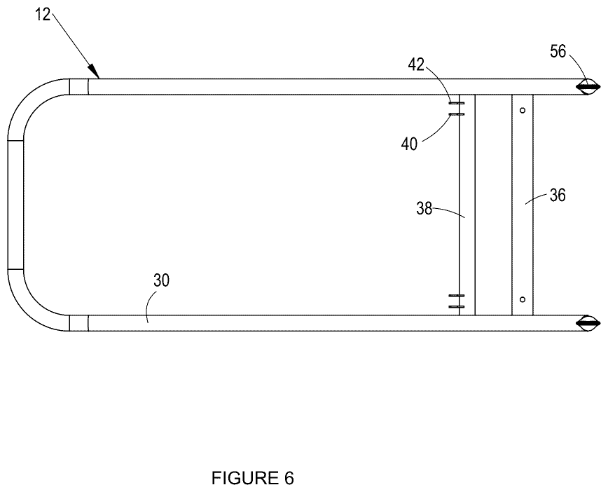

FIG. 4 shows a frame for an exercise machine, with the platform removed in this case for better detail of the frame itself and its structure. In normal operating conditions, a platform, of the types described herein, are mounted and fixed on the upper frame, to move with it, and comprise an exercise base or support for the user of the device. FIG. 5 of the drawings shows the movable frame in a more horizontal position, as compared to the position illustrated in FIG. 4 of the drawings. Generally, it is more difficult to exercise on a more horizontal surface, and the platform may be moved manually and/or automatically by programming to adopt many positions during a workout routine, according to the fitness level and needs of the user.

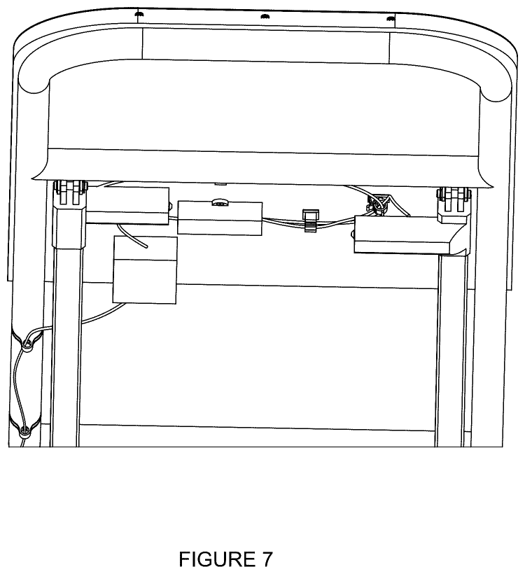

FIG. 7 of the drawings shows a detail illustrating the back of the platform, with motors, controllers, attachments, vibration motors and other hardware.

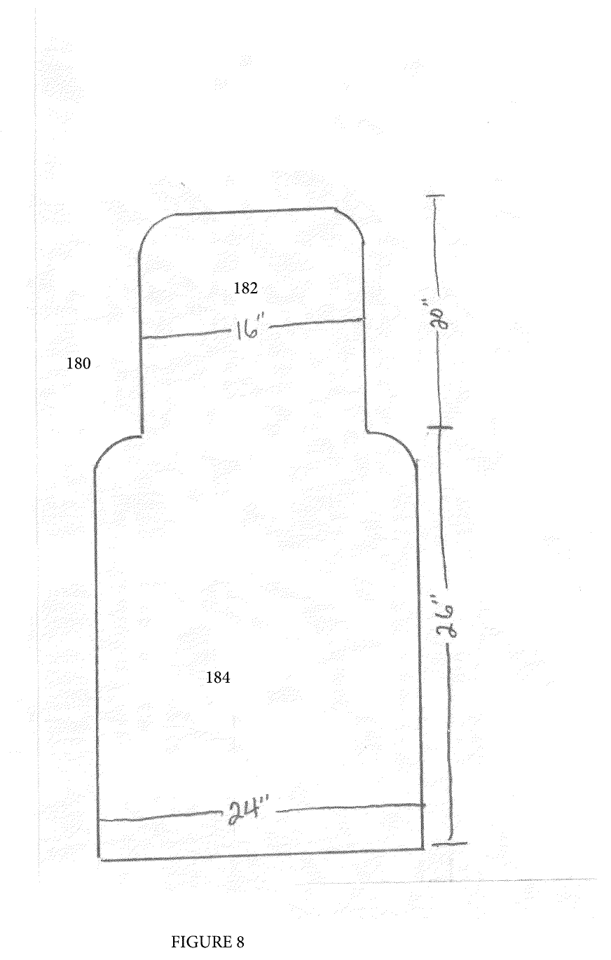

FIG. 8 of the drawings illustrates a platform 180 in accordance with one embodiment. The platform 180 has a top portion 182 of narrower dimensions, and a bottom portion 184 of wider dimensions. A transition curve is formed between these two portions. The platform having the narrower and wider dimensions allows for more exercises to be comfortably performed, and has, for example, the narrower upper portion 182 so that the arms of the user may extend below the upper surface of the platform for holding weights or carrying out other routines where this space is beneficial.

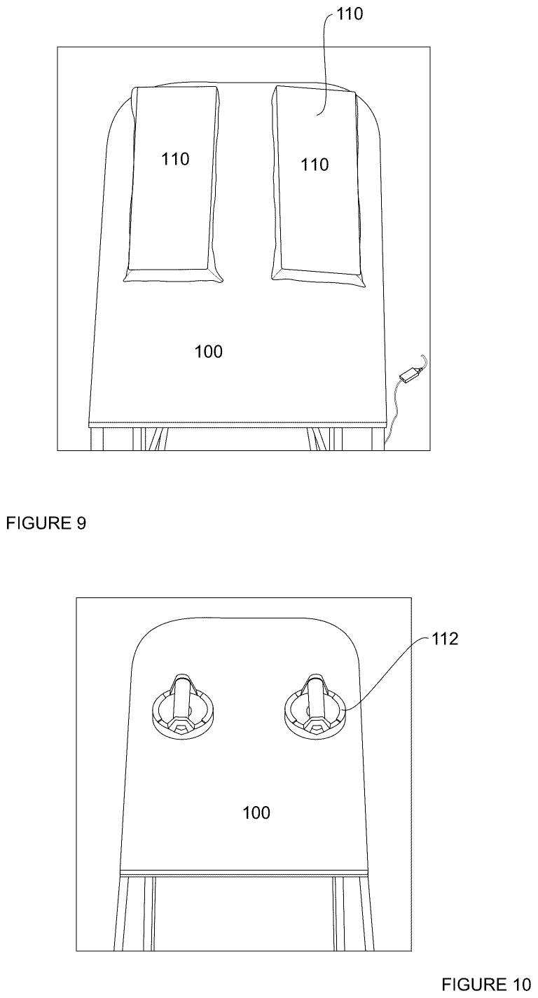

FIG. 9 of the drawings shows a close-up of the platform, including a pair of armrests 110 mounted on the platform. The armrest 110 may be cushioned to provide additional comfort for the user. FIG. 10 of the drawings shows a pair of handles 112 formed on the platform 100, which can be grasped or held by the person exercising, once again to provide additional stability to the user, and to help keep the user centered relative to the exercise device 10.

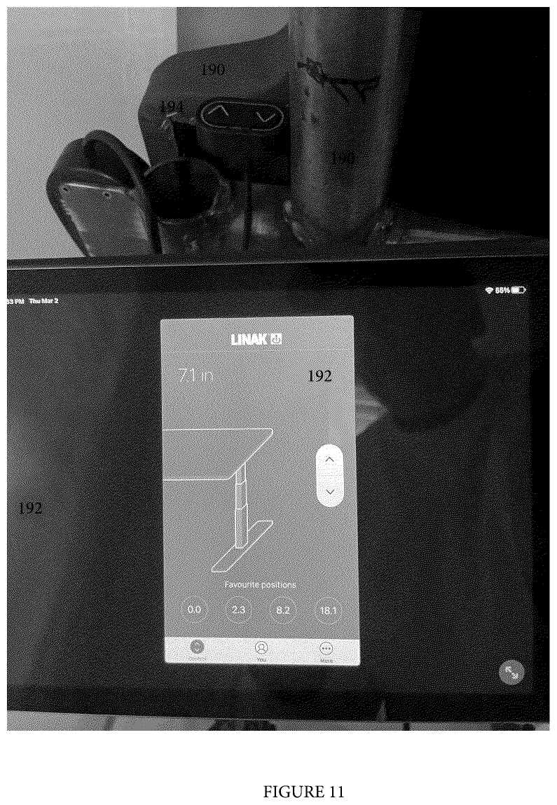

FIG. 11 of the drawings shows part of an exercise machine 190 and a tablet 192 of smart phone with an app to control the machine and set exercise routines. Further, a fixed programming device 194 can be seen attached to the machine 190.

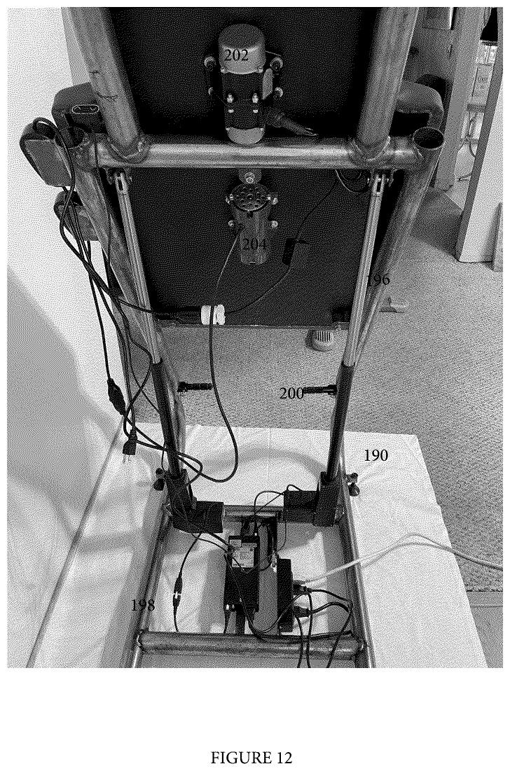

FIG. 12 illustrates the rear of the exercise machine 190 including an upper frame 196 and lower frame 198. Also shown are a pair of footrests 200 for foot support, which can be folded and unfolded as needed. There is an upper vibration motor 202 on the back of the platform, and a lower vibration motor 204 on the back of the platform, and each can be configured to provide a stronger to weaker vibration frequency. Vibrations may thus be like massages in character, or may be more vigorous for other exercises or affects.

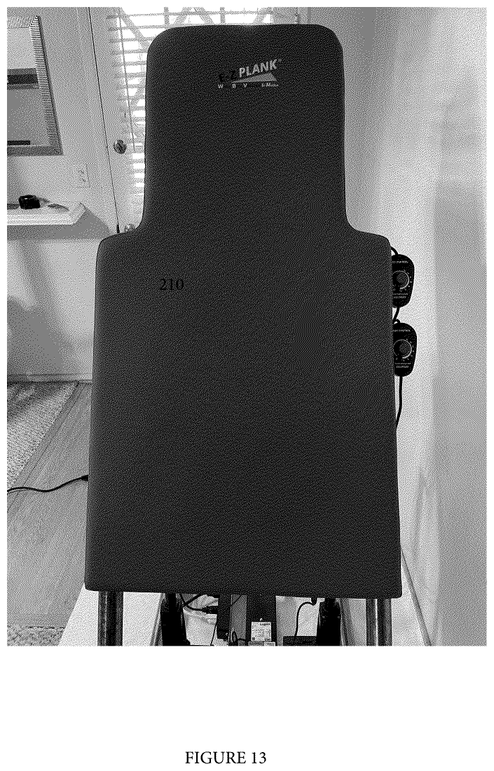

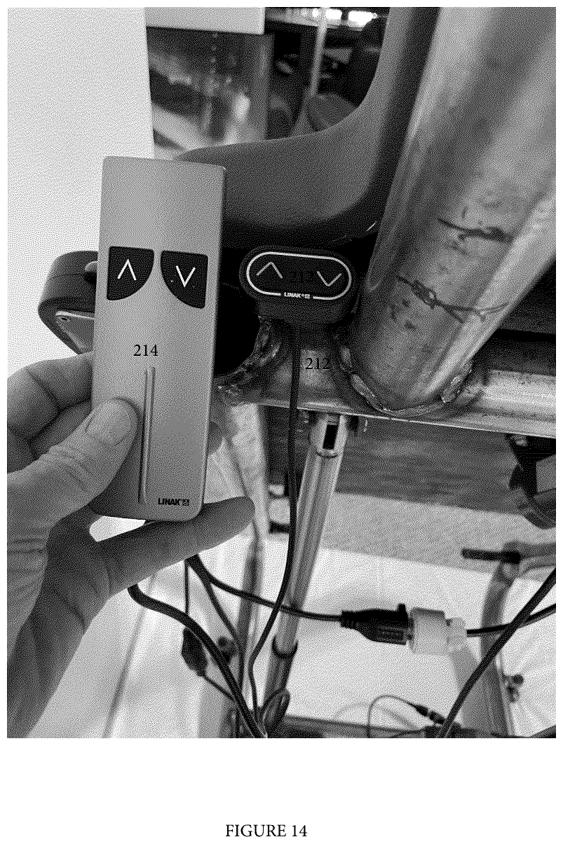

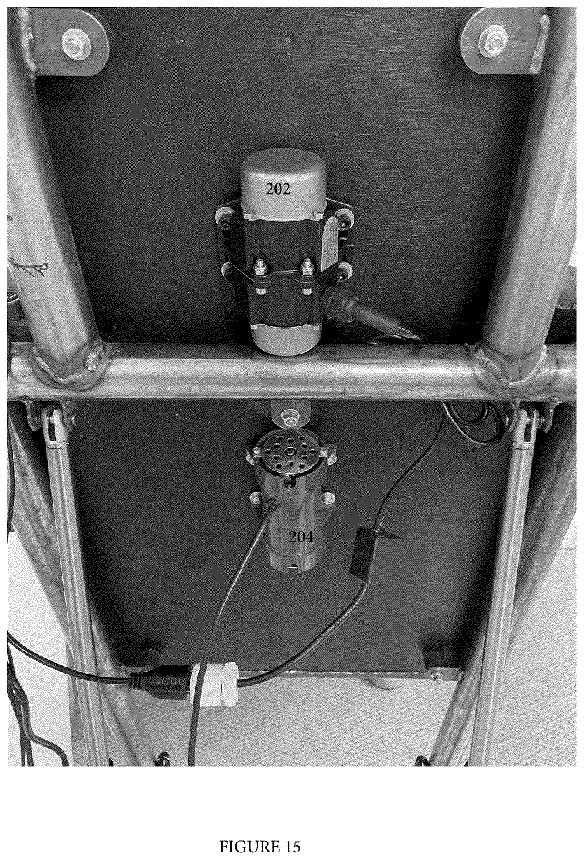

FIG. 13 shows a platform 210 similar to that illustrated in FIG. 8, with controls to the right of the platform for inputting commands or exercise programs which may be selected by the user, or for changing conditions in real time as determined by the user. FIG. 14 shows a portion of an exercise machine, and a fixed input device 212, as well as remote type input device 214, both of which may be used to program the machine or move from an existing condition.

FIG. 15 shows a detail of the back of the platform, clearly illustrating the upper vibration motor 202 and the lower vibration motor 204, each of which can be configured to emit vibrations of different intensities.

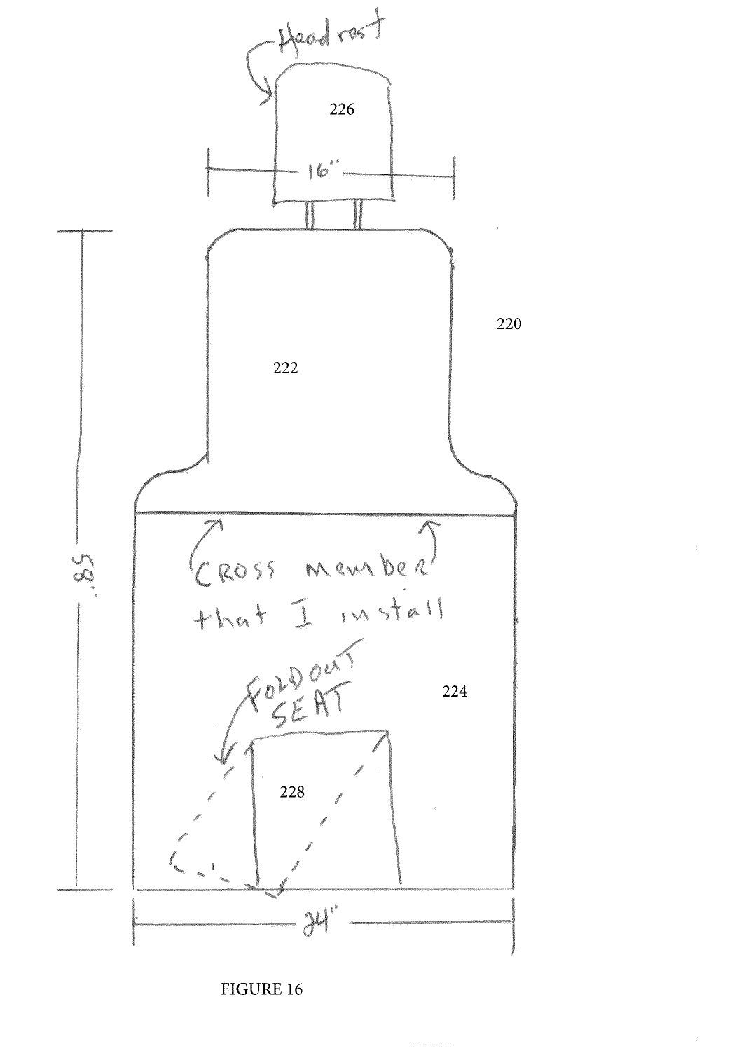

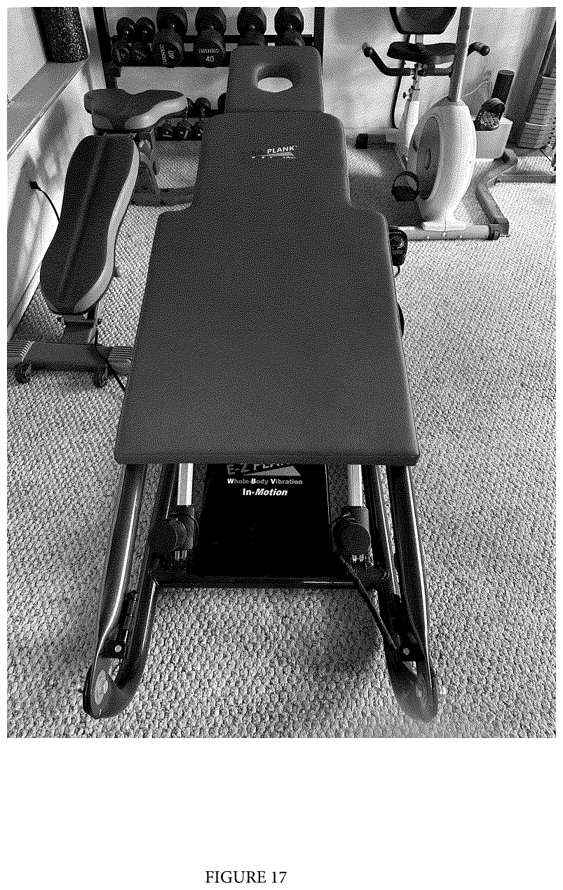

FIG. 16 is a front view of a platform 220 having an upper portion 222, a lower portion 224, an extendible headrest 226 and a foldout seat 228.

FIG. 17 of the drawings shows a front perspective view of an exercise machine in one embodiments, showing a variety of the features and components as described above.

It will be appreciated that the present invention therefore provides an exercise device which incorporates flexibility and adjustability in order to take into account the relative strengths and levels of fitness of the user. Moreover, as the user becomes stronger and acquires greater levels of fitness, the exercise device 10 of the invention can be adjusted and programmed so that it provides a more challenging piece of exercise equipment for the user. Platform movement and motor vibration can be modulated for many different routines which may vary in difficulty. As such, the exercise apparatus 10 of the invention continues to be valuable, and can be adapted to grow and be relevant with the increasing strength and fitness of the user. The exercise device is suitable for both strong and well trained individuals, as well as those who are not as fit or may have a physical challenge or disability. The exercise device may, furthermore, be adjusted by a user who may move the upper frame to be more vertical or more horizontal while in the course of an exercise routine so that the exercise is varied in real time and changes to produce a varied workout procedure. The upper frame position can, furthermore, move intermittently or constantly during a routine in order to vary it, and increase or decrease difficulty based on the health of the user.

The invention is not limited to the precise details described and illustrated herein. Variations can be made, and still fall within the scope of the invention. For example, the device may be made of different types of materials. Further, it may have different dimensions and shapes of the frames than those illustrated. The importance of the invention resides in the ability to move an upper movable frame 14 relative to a lower fixed frame 12, in various increments, and preferably by a motorized operating device, so as to provide many options and choices for the user. The invention may also be manufactured so as to be sufficiently strong to handle the weight of a large person, or adapted to accommodate a person with certain disabilities. Further, while two actuators have generally been described, the invention is not limited to this arrangement. There may be only one actuator, or they may be more than two such actuators.

### Further Details and Information

The invention may be able to achieve whole-body Vibration In-Motion capability, as described below.

### (1) Platform:

The invention may include a uniquely shaped platform that gives the user about 24 inches of horizontal width within the bottom about 26 inches of vertical height on the platform. In this area the user can do exercises like the plank, pushups, squats and other exercises. The platform narrows at the about 26 inches of vertical height point to about 16 inches of horizontal width and extends another about 20 inches of vertical height for an overall total of about 46 inches of vertical height. It will be appreciated that these distances and measurements may vary form one model or version of the invention to another such version.

### (2) Linear Actuators:

These are more powerful, and can support, lift and lower the platform with weights in excess of about 500 lbs. on it.

### (3) Remote Controls:

The invention offers a wireless handheld remote control, a side mounted wired remote control and a mobile app that sends a signal to a control box that raises and lowers the workout platform, preferably with one-touch. The mobile app can also be programmed to stop at four (this number may vary) different predetermined memory positions. The trainer has the ability to customize a user's workout by pre-programming the positions to which the actuators move the platform, and how long they may stay there before automatically moving to a new position.

### (4) Vibration Motors:

In one aspect, the invention has one vibration motor mounted in the middle of the back of the platform for a more gentle, smooth vibration that the user can engage for exercises like the plank, pushups, squats, etc. to increase or improve their results. This vibration motor's vibration may feel like getting a massage. The user can lay flat on the platform and engage this motor to relax tight muscles, tendons and joints.

There may be a second more powerful vibration motor mounted on the back of its platform near the top narrower area that offers the user a more intense vibration that increases the number of muscle contractions a user will have while doing weightlifting exercises. These added contractions may be able to give the user better results in less time. This arrangement also may offer a vibration speed controller to adjust vibration strength from, for example, 0 to 60 hz.

### (5) Wheels:

In one aspect, the invention includes two attached wheels to allow it to be easily moved to different locations in the gym or other room in which it is located so the user can work out on the whole-body vibration In-Motion machine of the invention in conjunction with all the weightlifting equipment in the gym. (These may include squat rack, dumbbell rack, smith machine, pulley machine, etc.)

### (6) Leveling Feet:

The device may provide for four leveling feet to keep it balanced, stable and safe.

### (7) Mounted Accessories:

Mounted accessories may include any one or more of the following: Power strip; control boxes; Bluetooth dongle mounted on a custom-built metal shelf that is attached to the bottom horseshoe shaped tubular frame away from the vibration motors, which are mounted on the top tubular frame, to avoid unwanted noise and rattling caused by being too close to the vibration motors; rotating pushup handles.

### (8) Whole-Body Vibration (WBV) in Motion:

The invention, in one aspect thereof, may allow the user to do all his or her exercises in the WBV mode (with wbv motor turned on) while the platform they are exercising on is in motion. An alternative option is to use with some or none of the motors, as best suits the user's needs in the exercise program being used.

### (9) Frame Tubing:

The frame tubing may be thicker and stronger, able to support 500+ lbs. Of body weight of the exerciser. The shape of the machine may be designed to accommodate the platform's specific shape.

(10) The invention thus is for a multi-purpose exercise machine where the user can do all these exercises and more:
(a). Traditional plank on hands
(b). Modified plank resting on forearms
(c). Side plank
(d). One leg plank
(e). One arm and one leg plank
(f). All other variations of the plank
(g). Pushups (all variations)
(h). Plantar fascia, Achilles tendon, Calf and hamstring stretch
(I). Barbell bench press with or without wbv
(j). Dumbbell bench press same as above
(k). Barbell incline bench press same
(l). Dumbbell incline bench press same
(m). Barbell curls
(n). Dumbbell curls
(o). Use wheels to move close to pulley machine to do all variations
(p). One arm dumbbell row
(q). Dumbbell fly's
®. Dumbbell squats
(s). Barbell squats
(t). Body weight squats
(u). Dumbbell triceps kickback
(v). Dumbbell overhead press
(w). Barbell overhead press
(x). Dumbbell overhead triceps extension
(y). Barbell overhead extension
(z). Dumbbell side lateral raise
(aa). Lay flat on back or stomach massage/relax muscles.

All of the above exercises can be done with or without turning the wbv motor (s) on while in motion.

The exercise may be able to put whole-body vibration in isometric motion. It may change the dynamic of traditional whole body vibration training, where one is in one static position while doing exercises. It makes this change by putting the user in motion while in the whole body vibration mode while doing one's exercises.

The exercise apparatus may incorporate a “voice activation” feature to operate its movements and functions. Commands through voice using this feature would be processed by a controller, which would signal to motors and other components to adopt a certain position or sequence of positions, timed or otherwise. One way of initiating the voice activation feature would be to say a programmed word to the exercise apparatus, along the same lines as Amazon's “Alexa” where the user says the activation word “ALEXA”. Thereafter, there may be a short pause for a couple of seconds, for example, followed by a command to move to or adopt a certain position or orientation. As an example only, the activation word or phrase may be “E-Z PLANK”, followed by a pause, and thereafter the commands such as “UP”, “DOWN”, “STOP”, “Vibration ON”, “Vibration OFF”, may be spoken, to name a few possibilities. Note that the voice activation system may be initiated or triggered by methods other than an activation word or phrase, as mentioned above. For example, there may be an ON/OFF switch, the activation may be automatic unless disabled, or there may be sensors to determine whether a person is using the exercise apparatus and only switch on at that time. These examples are just some of many potential options, and are not intended to be limiting.

As such, the user can control the motion and positions of the exercise apparatus by use of one or more of: (1) A wired controller; (2) A wireless handheld controller; (3) An app that can be downloaded to the cell phone or tablet or tablet of the user; and (4) Voice activation as described above. Further, other options for the control of the exercise apparatus will also fall within the scope of the invention.

Some advantages and/or benefits of the invention are as follows:
(1) whole body vibration exercise machine where user can do whole body vibration training while in motion.
(2) whole body vibration exercise machine where user can do weightlifting exercises while in motion.
(3) exercise machine that has an exercise platform with two different widths for doing weightlifting, planks, squats and pushups on the same platform.
(4) exercise machine that has an exercise platform with two different widths for doing weightlifting, planks, squats and pushups “while in the whole body vibration mode” on the same platform.
(5) whole body vibration machine that has one vibration motor with a lower more gentle rpm for users who want to maintain their current muscle tone and a another vibration motor with a higher more intense rpm for users who want to gain strength and muscle size. Both can be used separately or together.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. An exercise apparatus comprising:
a base frame including a base frame connector;
a movable frame including a movable frame connector, the movable frame connector being connected to the base frame connector such that the movable frame is rotatable relative to the base frame;
a platform mounted on the movable frame member to move with the movable frame member, the platform having at least two different widths;
an actuator located between the base frame and the movable frame, the actuator being operated by a motor, the actuator moving the movable frame relative to the base frame about the base frame connector so as to position the movable frame relative to the base frame in a selected position; and
a first vibration motor for vibrating one area of the platform and having a first intensity and a second vibration motor for vibrating another area of the platform and having a second intensity.

2. An exercise apparatus as claimed in claim 1 wherein at least one of the first vibration motor and the second vibration motor can be operated simultaneously with the operation of the actuator to change the position of the movable frame member while vibrating the platform to facilitate a whole body vibration exercise.

3. An exercise apparatus as claimed in claim 2 wherein the first vibration motor and the second vibration motor are both operated while the actuator changes the position of the movable frame member to facilitate the whole body vibration exercise.

4. An exercise apparatus as claimed in claim 1 wherein the first vibration motor is located at an upper portion of the platform and has a lower intensity.

5. An exercise apparatus as claimed in claim 1 wherein the second vibration motor is located at a lower portion of the platform and has a higher intensity.

6. An exercise apparatus as claimed in claim 1 wherein the first vibration motor is located at or near an upper end of the platform on a rear side thereof and imparts a mild vibration to the platform.

7. An exercise apparatus as claimed in claim 1 wherein the second vibration motor is located at about a midpoint of the platform on a rear side thereof and imparts a strong vibration to the platform.

8. An exercise apparatus as claimed in claim 1 wherein the first vibration motor and the second vibration motor have separate controls so that each can be set to a vibration intensity according to the preferences of a user.

9. An exercise apparatus as claimed in claim 1 further comprising a control input through which a user can set position and movement of the movable frame, vibration intensity of the first vibration motor, and vibration intensity of the second vibration motor.

10. An exercise apparatus as claimed in claim 9 wherein position and movement of the movable frame, vibration intensity of the first vibration motor, and vibration intensity of the second vibration motor can each be set to change over a specified period of time to provide a workout schedule.

11. An exercise apparatus as claimed in claim 1 wherein the platform has an upper portion having a first width, a lower portion having a second width, the first width being less than the second width.

12. An exercise apparatus as claimed in claim 11 wherein the first width is about 16 inches and the second width is about 24 inches.

13. An exercise apparatus as claimed in claim 12 wherein the upper portion of the platform comprises a foldable headrest, and the lower portion of the platform comprises a foldout seat.

14. An exercise apparatus as claimed in claim 8 further comprising a remote operator device for remotely operating the platform movement, the first vibration motor, and the second vibration motor so that each can be set by the remote operator device to the preferences of a user.

15. An exercise apparatus as claimed in claim 8 further comprising voice activation for remotely operating the platform movement, the first vibration motor, and the second vibration motor so that each can be set by the remote operator device to the preferences of a user.

16. A method of making an exercise apparatus, the method comprising:
providing a base frame including a base frame connector;
mounting a movable frame including a movable frame connector to the base frame connector such that the movable frame is rotatable relative to the base frame;
mounting a platform on the movable frame member so as be movable with the movable frame member, the platform having at least two different widths;
placing an actuator between the base frame and the movable frame, the actuator being operated by a motor, the actuator moving the movable frame relative to the base frame about the base frame connector so as to position the movable frame relative to the base frame in a selected position; and
locating a first vibration motor on the platform for vibrating one area of the platform and having a first intensity and locating a second vibration motor on the platform for vibrating another area of the platform and having a second intensity.

17. A method as claimed in claim 16 wherein at least one of the first vibration motor and the second vibration motor can be operated simultaneously with the operation of the actuator to change the position of the movable frame member while vibrating the platform to facilitate a whole body vibration exercise.

18. A method as claimed in claim 17 wherein the first vibration motor and the second vibration motor are both operated while the actuator changes the position of the movable frame member to facilitate the whole body vibration exercise.

19. A method as claimed in claim 16 wherein the first and second vibration motors are located at about an upper area and a midpoint respectively of the platform on a rear side thereof and impart a strong and a weaker vibration respectively to the platform.

20. A method as claimed in claim 16 wherein position and movement of the movable frame, vibration intensity of the first vibration motor, and vibration intensity of the second vibration motor can each be set to change over a specified period of time to provide a workout schedule.
